(19) United States
(12) Patent Application Publication
(10) Pub. No.: US 2004/0070371 A1
(43) Pub. Date: Apr. 15, 2004

(54) Power management of a battery operated computer system based on battery status

(75) Inventors: Lih Chern, Houston, TX (US); Lee W. Atkinson, Houston, TX (US); David J. DeLisle, Spring, TX (US); Richard S. Lin, Houston, TX (US); Dallas M. Barlow, Houston, TX (US)

Correspondence Address: CONLEY ROSE, P.C., P. O. BOX 3267, HOUSTON, TX, 77253-3267, US

(73) Assignee: Compaq Information Technologies Group, L.P., Houston, TX

(21) Appl. No.: 10/269,610

(22) Filed: Oct. 11, 2002

(51) Int. Cl. H02J 7/00

(52) U.S. Cl. 320/136

(57) ABSTRACT

A battery operated computer system implements a power management scheme based on battery behavior. The battery behavior that is monitored as part of the power management scheme may include battery temperature, current, voltage, and/or capacity. In response to one or more of these battery parameters exceeding a threshold, the computer transitions itself to a lower power consumption mode. In so doing, the potential for the battery to shut itself off due to being over-extended (e.g., over current) is reduced.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

1. Field of the Invention

The present invention generally relates to power management in a battery operated computer system. More particularly, the invention relates to power management based on one or more parameters (e.g., temperature, current, voltage, capacity/type) associated with the computer's battery.

2. Background of the Invention

Portable computers (also called “notebooks”) typically operate from either alternating current (“AC”) power or direct current (“DC”) power. AC power is supplied from a wall outlet to a power supply associated with the computer which converts the AC power to one or more suitable DC voltage levels. DC power is supplied by a battery pack. A battery pack contains multiple cells connected together as is commonly known.

There are various concerns that drive the design of portable computer with regard to its battery pack. All else being equal, it is desirable for the battery pack to be as large as possible. The “size” of a battery pack refers to the number of cells in the pack and the capacity of each cell. Larger battery packs are capable of supplying more power and for longer periods of time than smaller packs. Larger battery packs permit the portable computer to operate from battery power for longer periods of time which, of course, is highly desirable to the user of the computer.

However, all else is not equal. Larger battery packs naturally require more volume than smaller battery packs. Larger battery packs are also heavier than smaller packs. Thus, a tradeoff is made between battery life and system size and weight. One way that computer manufacturers have addressed these issues is by providing various models of portable computers with varying battery pack capacities. Some models of portable computers are constructed so as to accommodate larger battery packs than other models. Some computer models can even accommodate more than one type of battery pack. Such computers typically have a place in which a large pack can be inserted and another place (e.g., a multibay) in which a smaller pack can be inserted.

Another concern that drives portable computer design is functionality and performance. In general, computer users want computers to provide more and more functionality and performance. Many users want a portable computer to be just as powerful as a desktop machine. It is thus highly desirable to provide portable computers that include large, high resolution displays, ultra-fast central processing units (“CPUs”), DVD/CD drives, hard drives, floppy drives, USB ports, expansion slots, etc. These types of features can certainly be provided in a portable computer, but also require more power. When operating from AC power, the demand for power by a fully “loaded” portable computer is less of a problem than when the same computer is operating from battery power. A battery pack has only a finite amount of energy stored in it and thus, all else being equal, a power hungry computer will last for a shorter period of time on battery power than a more power conservative system. This issue has been addressed by providing larger battery packs in portable computers.

Yet another concern driving portable computer design is the computer's size and weight. All else being equal, a portable should be as light and small as possible. This concern has been addressed by miniaturizing the computer's components, packaging the various components in the computer as tightly as possible, using lighter weight materials where possible, etc.

As a result of improvements in portable computer technology in light of concerns such as those concerns described above, portable computer designs have reached a point in which it generally is not practical to make the battery packs any larger to increase the life of the battery or accommodate more power intensive functionality. Because the density of components inside a portable computer is very high and the components have been miniaturized extensively, increasing battery pack size is generally impractical. Quite simply, there is little room available to accommodate larger battery packs without increasing the overall size and weight of the computer, which is undesirable.

For all intents and purposes, battery packs have reached the outer limit on the practical size and thus capacity given present cell power density (i.e., the amount of energy per unit volume of a cell). Nevertheless, the demand is still there for computers to be developed that provide more and more functionality and more and more performance, which requires more electrical power. In short, the industry is rapidly approaching a point at which battery pack technology simply will not be able to keep up with desired increases in performance.

Many battery packs now include electronics which monitor the state of the battery and include safety features which protect the battery from harm. One aspect of the safety features provided in many battery packs is that the pack will shut itself off if it detects that it is being forced to provide too much current or becomes too hot. That is, if the battery pack's electronics detects that current or temperature in excess of a threshold is produced for more than a predetermined period of time, the electronics will simply shut the pack off. This means that a computer, operating from battery power, will “crash” (i.e., shut off). Battery pack shut down may be necessary to protect an over-extended pack, but is undesirable from the user's perspective. With battery packs reaching their power limit and computers continuing to be designed for increased, higher power performance, the potential for the pack to have to shut itself down resulting in a system crash is becoming increasingly more likely. Accordingly, a solution to this issue is needed.

### BRIEF SUMMARY OF THE INVENTION

The problems noted above are solved in large part by a battery operated computer system that controls its power state based on battery behavior. In accordance with one embodiment, the system monitors battery temperature, while in other embodiment battery current and voltage are used in the power management scheme. In yet another embodiment, battery type/capacity is used.

In a suitable manner, the battery parameter is compared to a threshold. If and when the battery parameter exceeds the threshold, the system responds by changing the power consumption state to result in less power being drawn from the battery. The change could entail throttling the CPU to an effective slower speed, dimming the display or other power saving techniques.

### BRIEF DESCRIPTION OF THE DRAWINGS

For a detailed description of the preferred embodiments of the invention, reference will now be made to the accompanying drawings in which:

FIG. 1 shows a system diagram of the preferred embodiment of the invention; and

FIG. 2 shows an exemplary ammeter circuit usable in conjunction with a preferred embodiment.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ”. Also, the term “couple” or “couples” is intended to mean either an indirect or direct electrical connection. Thus, if a first device couples to a second device, that connection may be through a direct electrical connection, or through an indirect electrical connection via other devices and connections.

### DETAILED DESCRIPTION OF THE PREFERRED EMBODIMENTS

The problems explained above are solved by monitoring the computer's battery pack for one or more conditions and altering the power consumption state of the computer as it becomes apparent that the battery pack is in danger of shutting itself off. The change in power state of the computer preferably is in favor of a state that draws less power from the battery. Thus, the system adjusts itself to minimize the potential for the battery's protection circuitry from shutting off the battery and crashing the system.

Various parameters associated with the battery, such as those explained below, can be monitored and are considered within the scope of this disclosure. Further, the change in the operational state of the system triggered by the battery parameter being monitored can be any desired change that results in lower power consumption. Such transitions to lower power states are well known in the art and include throttling down the computer's microprocessor and dimming the display. Throttling down the microprocessor refers to causing the processor to operate at a slower speed (e.g., 700 MHz instead of 1.5 GHz). A microprocessor requires less power to operate at a slower speed than at a faster speed. Examples of power saving transitions that a computer can perform are disclosed in U.S. Pat. Nos. 4,670,837 and 5,153,535, both of which are incorporated herein by reference. The preferred embodiment of the present invention employs one of these known power saving features in response to the state of the battery pack.

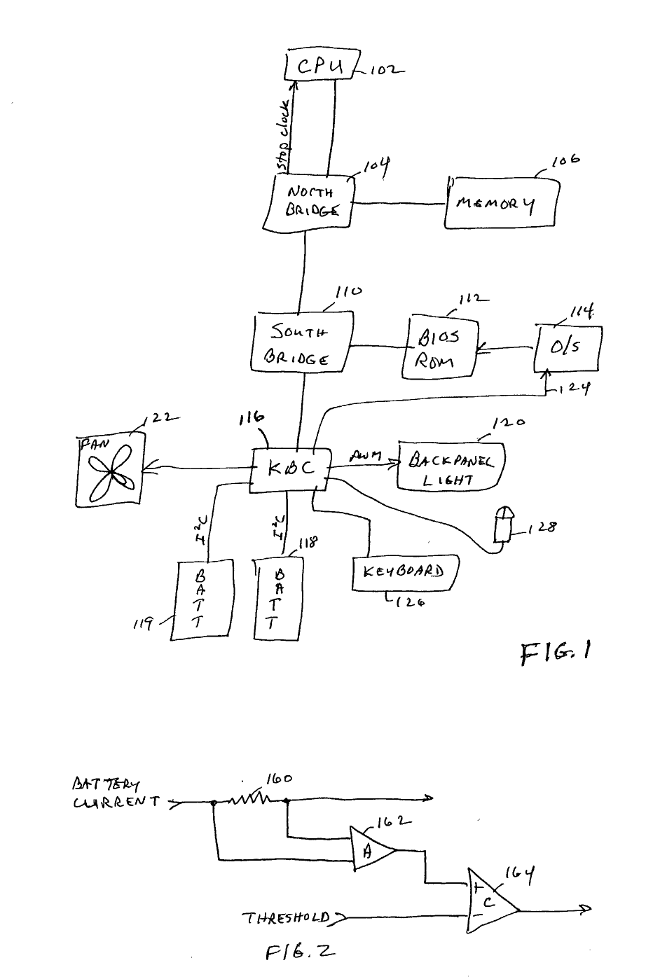

Referring now to FIG. 1, in accordance with the preferred embodiment of the invention, a computer system 100 comprises a CPU 102, a north bridge device 104, memory 106, a south bridge device 110, a BIOS ROM 112, a keyboard controller (“KBC”) 116, a battery 118, backpanel light 120, and a fan 122. The architecture shown in FIG. 1 is merely exemplary of numerous different architectures possible to implement the principles disclosed herein. North bridge device 104 couples to CPU 102, memory 106 and south bridge 110. South bridge 110 couples to a read only memory (“ROM”) 112 containing the basic input/output system (“BIOS”) firmware which is executed by CPU 102 to control numerous low level system functions as is well known to those of ordinary skill in the art. An operating system 114 is also included as part of system 100. The operating system 114, which is also well known in the art, comprises an application that is run by the CPU 102. Some of the functionality of the operating system is provided through the BIOS as indicated by the arrow coupling the operating system to the BIOS ROM 112.

The south bridge 110 also couples to the keyboard controller 116 which, in turn, couples to, not only a keyboard 126 and mouse 128, but also to a battery 118, the backpanel light 120 for a monitor and the fan 122. One or more additional batteries (e.g., battery 119) can also be included. The backpanel light 120 is part of a display (not specifically shown) which may be driven off the bus interconnecting bridges 104 and 110 or via the north bridge 104 itself. Although the display generally is driven by other logic in the system (e.g., the CPU 102 or a graphics processor), the keyboard controller 116 via a pulse width modulated signal controls the brightness level of the backpanel light that is part of the display. Accordingly, through the keyboard controller the backpanel light 120 can be dimmed to various desired levels. The fan 122 moves air through the system in an attempt to remove heat from the system. If desired, more than one fan 122 can be included in the system. The keyboard controller 116 controls the speed of the fan including whether the fan is on or off and, if on, the speed of rotation of the fan.

The battery 118 provides DC operating power for the system's electronics when operating on battery power. The battery 118 also includes an interface to the keyboard controller. In accordance with the preferred embodiment, the interface comprises an I²C bus. The I²C bus can be used to retrieve health and status information from the battery, as well as battery current, voltage and temperature. The battery 118, which may comprise an industry standard Smart Battery System (“SBS”) battery provided by Motorola, preferably includes a temperature sensor and digital electronics which provide the digital interface to the I²C bus, as well as provide safety functions to shut down the battery if, for example, the battery's temperature or current exceeds a threshold. The battery 118 also includes a “fuel gauge” integrated circuit which monitors the amount of energy remaining in the battery's cells. The fuel gauge can be any suitable fuel gauge device such as the bq2058 device provided by Benchmarq.

In accordance with one embodiment of the invention, the power state of the system 100 is tied to the temperature of, or associated with, the battery 118. In this embodiment, the system retrieves the battery's temperature via the I²C bus and reacts accordingly. If the temperature exceeds a predetermined or programmable threshold, the system will respond by transitioning to a lower power state as mentioned above. Preferably, the temperature threshold is set at a level so that the system will transition to the lower power state before the battery becomes so hot it damages itself That temperature threshold, of course, is system specific as would be known by one of ordinary skill in the art.

A number of techniques exist to retrieve temperature information from the battery. One suitable technique involves the use of Advanced Configuration and Power Interface (“ACPI”). ACPI is a well known mechanism by which the operating system 114 controls the power management of a computer system 100. The ACPI thermal design is based around regions called “thermal zones.” Typically, the entire computer system 100 is one large thermal zone. A number of parameters are programmed associated with the thermal zone. Such parameters, which will be described in more detail below, include temperature thresholds, and parameters which specify how the system is to respond to an over temperature condition. As noted above, ACPI preferably is implemented in the system's operating system. The parameters which control the behavior of the ACPI thermal zone preferably are set as part of the BIOS code. Thus, the BIOS contains code that defines the thermal zone. The BIOS code also provides code that is used by an ACPI control method called “_TMP.” The _TMP control method and the BIOS subroutine are executed when ACPI wants to know the temperature of the thermal zone.

In accordance with a preferred embodiment of the invention, a thermal zone is defined for the battery 118. This battery thermal zone is defined using various parameters such as TC0, TC1, TSP, PSL and PSV which are well known to those familiar with the ACPI standard. The TC0 and TC1 values represent thermal constants for passive cooling and may take on values such as 1 and 2, respectively. The TSP value is the thermal sampling period of passive cooling and is specified in units of tenths of seconds. The TSP value preferably is set so as to implement a polling period of 30 seconds, although other polling periods are acceptable as well. The PSV value specifies the temperature threshold above which passive cooling should be activated. This temperature value, as all temperature values in the ACPI standard, are specified in units of degrees Kelvin. For purposes of simplicity, however, temperatures in other units may be given in this disclosure. In one embodiment, the PSV value may be set to 53 degrees centigrade when the battery's fuel gauge is 30% or more full.

The PSL value points to the objects that are to be used to implement passive cooling. In this embodiment, the clock speed of the CPU 102 may be the object pointed to by the PSL value. By throttling back the CPU speed, the CPU can be made to draw less power. With the battery's temperature defined to be in a thermal zone and the passive cooling response to be throttling back the CPU, the battery's internal protection circuit can be precluded from shutting off the battery due to excessive heat generation by reducing the power draw by the CPU. The PSL value may also cause the backpanel light 120 to dim.

Referring still to FIG. 1, the keyboard controller 116 preferably contains one or more programmable registers (not specifically shown) that cause the keyboard controller to poll the battery 118 for its temperature at a certain rate. The rate may be the same rate as the TSP value explained above. Further, the operating system and/or BIOS preferably program the keyboard controller's register with this value and can reprogram the register to change the frequency of polling operation performed by the keyboard controller. During each poll, the keyboard controller 116 retrieves the contents of a predetermined register (not specifically shown) in the battery 118 over the I²C bus and preferably from the battery's fuel gauge device.

The keyboard controller 116 also includes a register that includes a temperature threshold which is programmed by the operating system via ACPI (e.g., the PSV value). During each polling operation, the keyboard controller 116 compares the battery's temperature to the threshold. When the threshold is exceeded, the keyboard controller 116 asserts a system control interrupt (“SCI”) 124 which is an interrupt mechanism well known to those of ordinary skill in the art. The SCI assertion is detected by the ACPI driver. The ACPI driver responds by reading the temperature of the battery using the _TMP control method discussed previously and compares the battery temperature to the passive temperature threshold (“PSV”). If the battery's temperature exceeds the PSV limit, the operating system initiates passive cooling in accordance with the object specified by PSL. PSL may dictate that the CPU 102 is to be throttled down to an effective slower speed. This preferably is accomplished by toggling a stop clock signal to the CPU which causes its internal clock to cease when stop clock is asserted. In effect, the duty cycle of the CPU's internal clock is reduced, thereby reducing the total average power draw by the CPU. With the CPU 102 drawing less power, the battery 118 naturally will not have to produce as much power and thus is less likely to exceed its maximum temperature or current limit above which the battery's internal protection circuitry will shut off the battery and crash the entire system. Of course, other lower power consumption states are possible as well, such as dimming the backpanel light.

In accordance with another embodiment, rather than tying the system's power state to the battery's temperature, the response is tied to the battery's current (either peak or average). Accordingly, when the battery's output current to the system exceeds a threshold, the system responds in a suitable manner to reduce the power draw on the battery. The response may be to throttle back the CPU as explained above, dim the display's backpanel light 120, or any other desired technique as explained above. This embodiment can be implemented using ACPI. The battery's current will be defined as a “thermal” zone, although it is understood within the ACPI standard that thermal zones apply to temperature. As before, the PSV and other values are defined for the battery's thermal zone. The PSV value may be specified as 53 degrees centigrade, or another temperature. When the keyboard controller 116 polls the battery's fuel gauge for a current reading, the keyboard controller preferably converts the current reading to a temperature value. That is, any suitable formula is used to convert or scale battery current to a value that is commensurate with the PSV settings defined by the ACPI standard. For example, if it is desired for passive cooling to begin when battery current exceeds 3 amps, a formula can be contrived that results in 3 amps being converted to a value of 53, or whatever is the PSV trip point. One suitable formula is:

temp=(X)(current)

where “current” is battery current and “X” is any suitable factor such as 53/3 or 17.67 for the example of a PSV of 53 degrees centigrade. Of course, it should be understood that the factor X will actually be adjusted to take into account that temperature in the ACPI standard is given in terms of degrees Kelvin.

Battery current can also be monitored without the use of an ACPI thermal zone. In accordance with another embodiment of the invention, an ammeter circuit permits the battery current. FIG. 2 shows one embodiment of a suitable ammeter circuit. A low value resistor R (e.g., 20 milliohms) is placed in series with the battery's current flow. The voltage generated across the series resistor 160 is proportional to the battery current and is amplified by the amplifier 162. The output signal from the amplifier is compared to a threshold signal by a comparator 164. The output of the comparator thus indicates whether the battery current is above or below the threshold. In accordance with known techniques, the comparator 164 preferably also includes hysterisis to prevent oscillations in the comparator's output when the input signal hovers around the threshold. The comparator 164 output signal can then be used to cause the CPU 102 to be throttled down or other suitable response.

The ammeter circuit can be implemented outside the battery pack such as on the computer system's motherboard. Alternatively, the ammeter circuit, or at least the series resistor 160, may be included in the battery pack 118. The battery pack can respond by generating a dedicated “overcurrent” signal to the system via a connection to the keyboard controller 116 or other logic in the system. Instead of an overcurrent signal, the battery pack's fuel gauge may generate an “attention” signal over the I2C bus.

In yet another embodiment, the system power consumption state can be tied to the voltage of the battery pack. In general, as a battery is discharged its voltage drops. To maintain constant power output, however, the battery's current increases. Thus, as the battery becomes more and more discharged, its current output may reach an unacceptably high level. An ACPI thermal zone can be set up to monitor the battery pack voltage which is obtainable from the pack's fuel gauge. As with battery current, the voltage is translated into a value commensurate with the PSV value set for the thermal zone.

In accordance with yet another embodiment of the invention, another way to limit battery current to prevent the battery from shutting itself down is to predict whether the battery is capable of supporting a fully functioning system. Some battery operated computer systems can accommodate at least two different size (i.e., capacity) battery packs—for example, a larger pack which can provide higher current levels for longer periods of time and a smaller pack which is limited in terms of peak current and battery life. In such systems, the smaller pack may not be capable of supporting the CPU operating at full speed while various other activities are occurring (e.g., hard disk spinning, etc.). Some prior computer systems have changed the operational state of the computer system depending on whether the system is operating from AC or DC power. In accordance with a preferred embodiment of the invention, the operational state of the computer is adjusted depending on which one of a plurality of battery packs is actively being used to supply power for the system. Thus, if a lower capacity pack is being used, a lower power consumption state is activated and if a larger capacity pack is being used a higher power consumption state is activated. The lower power consumption can include CPU throttling, display backpanel light dimming, and the like as explained previously. The system can determine which one of a plurality of battery packs is being used by reading the value of a keyboard controller register to which is written a value, preferably indicative of the design power capacity of the pack. If the keyboard controller detects a large capacity pack (e.g., over 40 watts-hours), then it will report a first value (e.g., a “0”) then the _PPC (Performance Present Capabilities) command, which is well known in the ACPI 2.0 specification. This command/value indicates that highest performance processor state (e.g., P0) available. If, on the other hand, a small battery pack is detected by reading the keyboard controller register noted above, a second value (e.g., a “1”) is reported through the _PPC command indicating that a lower power state (e.g., P1, P2, etc.) is the fastest state available to use.

In addition to, or instead of, passive cooling, the preferred embodiments may include active cooling. Active cooling involves the use of the fan 122 to move air through the system. The ACPI standard provides for the ability to set a temperature threshold that triggers active cooling. The ACPI parameter is ACX and is well known in the art. A mix of passive and active cooling can be implemented based on battery state.

The various preferred embodiments of the invention discussed above provide a computer system the ability to prevent the system from crashing due to the battery pack's internal safety circuitry detecting an impermissible condition (e.g., overcurrent, over temperature, etc.). Accordingly, the system is placed into one of various lower power consumption states based on the behavior of the battery such as battery current, voltage, temperature and type/capacity.

The scope of this disclosure, of course, includes the battery pack itself. The pack includes one or more cells that produce DC power and monitoring electronics coupled to the cells. The monitoring electronics may include an ammeter as noted above, and generate an alert signal through an external pin on the pack. This signal alerts the pack's host system as to an imminently occurring problem with the pack (e.g., excessive battery current). The host can respond in a way to prevent the pack's electronics from shutting it down.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A computer system, comprising:
a CPU;
memory coupled to said CPU;
a battery to provide DC power for the computer signal; and
a display coupled to said CPU;
wherein a parameter associated with said battery is compared to a threshold and when said battery parameter exceeds said threshold, said system transitions to a lower power consumption state.

2. The computer system of claim 1 wherein said battery parameter comprises battery temperature.

3. The computer system of claim 1 wherein said battery parameter comprises battery current.

4. The computer system of claim 1 wherein said battery parameter comprises battery voltage.

5. The computer system of claim 1 wherein said battery parameter comprises battery capacity.

6. The computer system of claim 1 wherein said lower power consumption state includes slowing down said CPU.

7. The computer system of claim 6 wherein said battery parameter comprises battery temperature.

8. The computer system of claim 6 wherein said battery parameter comprises battery current.

9. The computer system of claim 6 wherein said battery parameter comprises battery voltage.

10. The computer system of claim 6 wherein said battery parameter comprises battery capacity.

11. The computer system of claim 1 wherein said lower power consumption state includes dimming said display.

12. A method of power management in a computer system, comprising:
(a) monitoring a parameter associated with a battery;
(b) comparing the parameter to a threshold; and
(c) changing a power state of the computer system to consume less power if said parameter exceeds said threshold.

13. The method of claim 12 wherein said parameter comprises battery temperature.

14. The method of claim 12 wherein said parameter comprises battery current.

15. The method of claim 12 wherein said parameter comprises battery voltage.

16. The method of claim 12 wherein said parameter comprises battery capacity.

17. The method of claim 12 wherein (c) includes slowing down a CPU.

18. The method of claim 17 wherein said parameter comprises battery temperature.

19. The method of claim 17 wherein said parameter comprises battery current.

20. The method of claim 17 wherein said parameter comprises battery voltage.

21. The method of claim 17 wherein said parameter comprises battery capacity.

22. The method of claim 12 wherein (c) includes dimming a display.

23. A power management subsystem usable in a computer system, comprising:
a battery;
a keyboard controller coupled to said battery; and
power management logic operable to control a power state of the computer system based on a parameter associated with the battery;
wherein said keyboard controller polls the battery for said parameter and asserts an interrupt to said power management logic when said parameter exceeds a threshold and said power management logic responds by causing a change in the power state.

24. The power management subsystem of claim 23 wherein said power state change caused by said power management logic includes slowing down a CPU.

25. The power management subsystem of claim 23, wherein said power state change caused by said power management logic includes dimming a display.

26. The power management subsystem of claim 23 wherein said parameter comprises battery temperature.

27. The power management subsystem of claim 23 wherein said parameter comprises battery current.

28. The power management subsystem of claim 23 wherein said parameter comprises battery voltage.

29. The power management subsystem of claim 23 wherein said parameter comprises battery capacity.

30. A battery pack, comprising:
at least one cell that provides output current; and
monitoring electronics coupled to said at least one cell and capable of generating an alert signal if said current exceeds a predetermined threshold and said pack continues to produce output current even when said alert signal is generated.
